(19) United States
(12) Patent Application Publication
(10) Pub. No.: US 2017/0176205 A1
(43) Pub. Date: Jun. 22, 2017

(54) VEHICLE NAVIGATION SYSTEM THAT INCLUDES SAFETY INFORMATION

(71) Applicant: JAGUAR LAND ROVER LIMITED, Warwickshire (GB)

(72) Inventors: Matt Jones, Portland, OR (US); Paul Wheller, Portland, OR (US); Peter Bontrager, Portland, OR (US)

(21) Appl. No.: 14/972,783

(22) Filed: Dec. 17, 2015

(51) Int. Cl. G01C 21/36

(52) U.S. Cl. CPC G01C 21/36

(57) ABSTRACT

An illustrative example vehicle navigation system includes a user interface having at least a display screen for providing a display output to a user. A controller, which includes at least one processor and memory associated with the processor, determines an area represented by the display. The controller determines at least one safety characteristic of at least one portion of the area represented by the display. The controller causes the user interface to include an indication of the determined safety characteristic with the display.

### TECHNICAL FIELD

The present disclosure relates to providing information to assist a driver to decide whether to travel on a particular route or to potential locations of interest based on a safety characteristic of a region or area. Aspects of the invention relate to a system, a vehicle and a method.

### BACKGROUND

With advances in computing technology, it has become increasingly possible to incorporate information and entertainment devices on vehicles. Navigation systems are one example that rely upon computing technology for providing automated route guidance to a driver. Such systems have proven useful and have gained widespread acceptance. Some such systems provide the ability for an individual to search for locations based on a category, for example. User experience with such systems can be less than satisfactory because of the limitations on how the user may make a request and the way in which information is provided to the user. Additionally, the amount of user involvement required for making such a request can make it challenging except when the vehicle is stationary and the individual is not actively driving the vehicle.

Another shortcoming of such systems is that the amount of information regarding a location identified in such a search is typically limited to an identity of the location and possibly an approximate distance to the location. Such limited information may present difficulties or leave uncertainties for an individual who is not familiar with the region or area surrounding the identified location.

It would be beneficial to be able to provide additional information through a vehicle navigation system in a way that meets an individual's desires or needs in a more convenient and effective manner.

### SUMMARY OF THE INVENTION

Aspects and embodiments of the invention provide a system, a method and a vehicle as claimed in the appended claims.

According to an aspect of the invention, there is provided a vehicle navigation system that includes a user interface means for providing an output including at least a display to a user. The system also includes control means for determining an area represented by the display, determining at least one safety characteristic of at least portion of the area represented by the display, and causing the user interface means to include an indication of the determined safety characteristic with the display.

In an example embodiment having one or more features of the system of the previous paragraph, the control means comprises a computing device including at least one processor and memory associated with the computing device. The user interface means comprises at least a display screen and may include a speaker for providing audio output. The user interface means includes an input device that allows a user to provide input to the system.

In an example embodiment having one or more features of the system of any of the previous paragraphs, the control means determines the safety characteristic based on information from a remotely accessible database.

In an example embodiment having one or more features of the system of any of the previous paragraphs, the safety characteristic is based on at least one of lighting in the portion of the area, a crime rate in the portion of the area, information regarding reported crimes in the portion of the area, and information regarding a potential threat in the portion of the area.

In an example embodiment having one or more features of the system of any of the previous paragraphs, the indication of the safety characteristic comprises a color on the display screen. The color is a first color when the safety characteristic corresponds to a first expectation that an individual may be in danger of a possible crime or threat in the portion of the area. The color is a second, different color when the safety characteristic corresponds to a second, higher expectation that an individual may be in danger of a possible crime or threat in the portion of the area.

In an example embodiment having one or more features of the system of any of the previous paragraphs, the control means determines a current position of a vehicle associated with the system, the output includes an indication of the current position of the vehicle within the area, the representation of the area includes the first color for portions of the area where the first expectation exists and includes the second color for portions of the area where the second expectation exists.

In an example embodiment having one or more features of the system of any of the previous paragraphs, the indication of the at least one safety characteristic comprises at least one of text or a symbol.

In an example embodiment having one or more features of the system of any of the previous paragraphs, the user interface means receives user input regarding at least one criterion of interest to the user. The control means identifies a place of potential interest as a location that satisfies the at least one criterion. The control means determines the at least one safety characteristic for a vicinity of the identified place of potential interest. The user interface means includes an indication of the determined at least one safety characteristic associated with an indication of the identified place of potential interest.

In an example embodiment having one or more features of the system of any of the previous paragraphs, the user interface receives user input regarding a desired search area surrounding a position of a vehicle associated with the system. The control means identifies any locations within the desired search area that satisfy the at least one criterion as places of potential interest. The output includes an indication of a position of any identified place of potential interest relative to the position of the vehicle.

In an example embodiment having one or more features of the system of any of the previous paragraphs, the position of the vehicle is a current position of the vehicle, the control means dynamically updates a position of the desired search area based on changes in the current position of the vehicle, and dynamically identifies any places of potential interest based on the updated desired search area.

In an example embodiment having one or more features of the system of any of the previous paragraphs, the position of the vehicle is a predetermined route and the control means identifies any locations within the desired search area along the route.

According to another aspect of the invention, there is provided a vehicle comprising the system of any of the previous paragraphs.

According to another aspect of the invention, there is provided a method of providing information to a driver of a vehicle through a vehicle navigation system that includes at least a display screen. The method includes determining an area represented by a display on the display screen; determining at least one safety characteristic of at least one portion of the area represented by the display; and including an indication of the determined safety characteristic with the display.

An example embodiment having one or more features of the method of any of the previous paragraphs includes determining the safety characteristic based on information from a remotely accessible database.

In an example embodiment having one or more features of the method of any of the previous paragraphs, the safety characteristic is based on at least one of lighting in the portion of the area, a crime rate in the portion of the area, information regarding reported crimes in the portion of the area, and information regarding a potential threat in the portion of the area.

In an example embodiment having one or more features of the method of any of the previous paragraphs, the indication of the safety characterization comprises a color on the display. The color is a first color when the safety characteristic corresponds to a first expectation whether an individual may be in danger of a possible crime or threat in the portion of the area. The color is a second, different color when the safety characteristic corresponds to a second, higher expectation that an individual may be in danger of a possible crime or threat in the portion of the area.

An example embodiment having one or more features of the method of any of the previous paragraphs includes determining a current position of the vehicle, providing an indication of the current position of the vehicle on the display with the area represented by the display being an area surrounding the current position of the vehicle and including the first color for portions of the area surrounding the vehicle where the first expectation exists and including the second color for portions of the area surrounding the vehicle where the second expectation exists.

In an example embodiment having one or more features of the method of any of the previous paragraphs, the indication of the at least one safety characteristic comprises at least one of text and a symbol.

An example embodiment having one or more features of the method of any of the previous paragraphs includes, receiving user input regarding at least one criterion of interest to the user, identifying the place of potential interest as a location that satisfies the at least one criterion, determining the at least one safety characteristic of a vicinity of the identified place of potential interest, and including an indication of the at least one safety characteristic with an indication of the identified place of potential interest.

An example embodiment having one or more features of the method of any of the previous paragraphs includes, receiving user input regarding a desired search area surrounding a position of the vehicle, identifying any location within the desired search area that satisfy the at least one criterion as a place of potential interest, and including an indication of a position of any identified place of potential interest relative to the position of the vehicle.

In an example embodiment having one or more features of the method of any of the previous paragraphs, the position of the vehicle is a current position of the vehicle and the method includes dynamically updating a position of the desired search area based at least on changes in the current position of the vehicle and dynamically identifying any places of potential interest based on the updated desired search area.

In an example embodiment having one or more features of the methods of any of the previous paragraphs, the position of the vehicle is along a predetermined route and the method includes identifying any locations within the desired search area along the route.

According to another aspect of the invention, there is provided a vehicle comprising a controller and a display screen configured to perform the method of any of the previous paragraphs.

According to another aspect of the invention, there is provided a vehicle navigation system including a user interface having at least a display screen for providing a display output to a user. A controller, which includes at least one processor and memory associated with the processor, determines an area represented by the display. The controller determines at least one safety characteristic of at least one portion of the area represented by the display. The controller causes the user interface to include an indication of the determined safety characteristic with the display.

Within the scope of this document it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 diagrammatically illustrates an example embodiment of a system designed according to an embodiment of this invention associated with a vehicle;

FIG. 2 schematically illustrates selected portions of the example system of FIG. 1;

FIG. 3 is a flowchart diagram summarizing an example approach to providing safety information to a user;

FIG. 4 diagrammatically illustrates an example type of user output provided according to an embodiment of this invention;

FIG. 5 is a flowchart diagram summarizing another example approach; and

FIG. 6 illustrates another example type of output provided to a user according to an embodiment of this invention.

### DETAILED DESCRIPTION

Embodiments of this invention provide safety characteristic information to an individual within a vehicle to assist that individual in deciding whether to travel along a route or to a place of potential interest in a customizable manner.

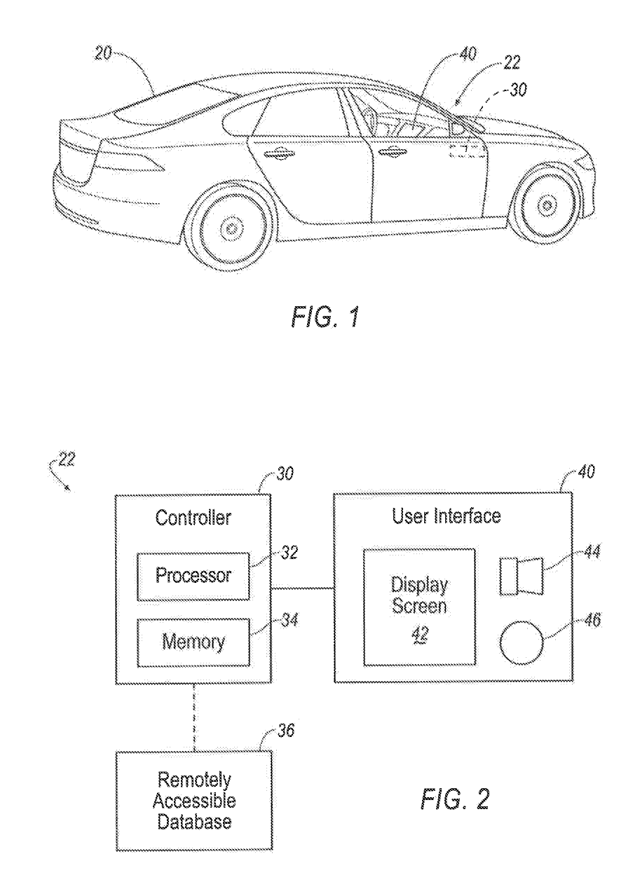

Referring to FIGS. 1 and 2, a vehicle 20 has an associated navigation system 22. A control means 30 includes at least one computing device 32, such as an electronic controller or a processor, and memory 34 associated with the computing device. The computing device 32 is a navigation system controller particularly configured to perform functions and automate determinations associated with a vehicle navigation system. The control means 30 is capable of processing navigation information using known techniques.

For discussion purposes, the control means 30 may be referred to as a controller in the following description.

The computing device 32 can comprise a control unit or computational device having one or more electronic processors (e.g., a microprocessor, a microcontroller, an application specific integrated circuit (ASIC), etc.), and may comprise a single device or multiple devices that collectively operate as the computing device 32. The term “controller,” “control unit,” or “computational device” may include a single controller, control unit, or computational device, and a plurality of controllers, control units, or computational devices collectively operating to provide the required control functionality.

A set of instructions is provided in the memory 34 in some embodiments which, when executed, cause the controller 30 to implement the control techniques mentioned in this description (including some or all of the functionality required for the described method). The set of instructions could be embedded in one or more electronic processors of the computing device 32; or alternatively, the set of instructions could be provided as software to be executed in the computing device 32. Given this description those skilled in the art will realize what type of hardware, software, firmware, or a combination of these will best suit their particular needs.

The memory 34 may include information useful for navigation determinations in addition to the instructions mentioned above. The memory 34 may be on board the vehicle 20, a remotely accessible data storage, or a combination of on board and remote memory. Although the computing device 32 and the memory 34 are schematically shown separately in the drawing, that is primarily for discussion purposes. The computing device 32 and the memory 34 may be integrated into a single device or component. Additionally, they may be a portion of a controller that is used for other purposes, such as a vehicle engine control unit.

The controller 30 has access to a remotely accessible database 36 as schematically shown in FIG. 2. The system 22 uses known wireless communication techniques to access the database 36. In one example, the database 36 is available over the Internet. In some examples, the database 36 is available through a subscription service. In some examples, the controller 30 has access to multiple databases 36 with at least one of them being available over the Internet and at least one other being available through a subscription service.

The database 36 includes information pertinent to the safety of individuals in various vicinities, locations or regions. Example information in some embodiments includes crime rate information based on reported crimes against individuals or property in the location or region or police reports regarding such crimes. Other types information included in some embodiments includes governmental security agency alerts based on intelligence regarding potential threats within particular areas, such as a suspected terrorist attack, etc. Some examples include lighting condition information, such as whether an area is well lit at night. Lighting information is useful, for example, to determine if a parking lot or walking path is dark, which can affect a sense of safety or a level of risk. A variety of information may be used to define or determine a safety characteristic for a particular vicinity or region and those skilled in the art who have the benefit of this description may include other sources or types of information that best suit their particular needs.

The type of information included in the database 36 allows the controller 30 to determine whether a particular location is in a vicinity that has a reputation of being a relatively dangerous or high crime area. Such a determination allows for providing information to an individual user of the system 22 regarding an expectation whether the individual is likely to be in danger of being a victim of a crime.

A user interface means 40 includes at least a display screen 42 that provides a visual output to an individual within the vehicle 20. An audio output or speaker 44 is provided in the illustrated example to provide audible indications regarding information of use or interest to an individual within the vehicle 20. The example user interface means 40 includes an input mechanism 46, such as a keypad, dial, switch, or pointer device, to facilitate the user providing input to the system 22.

According to an example embodiment, the display screen 42 is a touch screen that is configured to detect a user gesture near the screen utilizing known close proximity or contact sensing techniques. In this example, the display screen 42 serves as an output and input device of the user interface means 40.

One feature of the illustrated embodiment is an ability to provide information to an individual that will assist that individual in making a decision whether to detour from a current route to places of potential interest. For example, a driver of the vehicle 20 may need to visit an automated teller machine to withdraw money but wants to avoid doing so at a location where there is an elevated risk of being robbed. Another driver may have recently purchased the vehicle 20 and wishes to avoid parking in an area where there is an increased risk that someone will break into or steal the vehicle 20. The example embodiment provides information to such drivers to assist them to make more informed decisions about which locations are better suited to address their concerns and meet their needs.

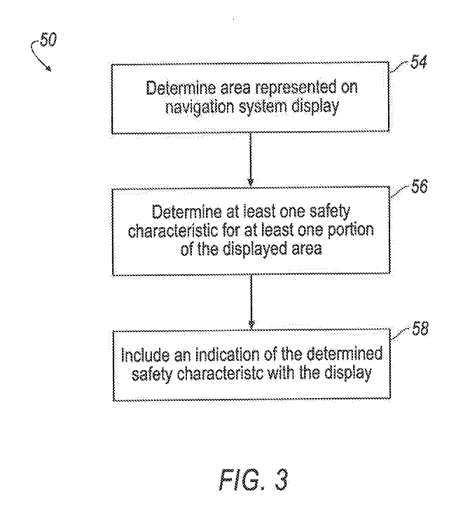

FIG. 3 is a flowchart diagram 50 summarizing an example method of providing information to an individual in the vehicle 20 through the navigation system 22. At 54, the controller 30 determines an area represented on the navigation system display provided on the display screen 42. At 56, the controller 30 determines at least one safety characteristic for at least one portion of the area represented on the display. The safety characteristic may be based upon lighting conditions, a crime rate, police reports, or information regarding potential threats. Such information is obtained by the controller 30 from the remotely accessible database 36. When there is at least one portion of the area represented on the display that includes a safety characteristic that may be of interest to a user, at 58, the controller 30 controls the user interface means 40 to include an indication of the determined safety characteristic with the display.

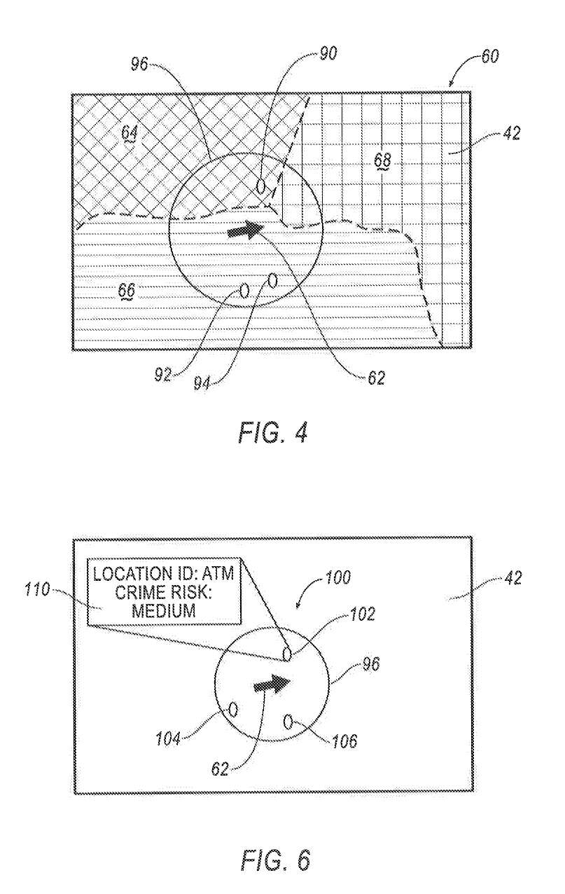

FIG. 4 schematically illustrates an example output display 60. This example includes an indication at 62 of the current position and direction of movement of the vehicle 20. The area generally surrounding the current position of the vehicle is represented on the display and is divided into regions or portions 64, 66 and 68. Each of those portions corresponds to a region or vicinity having a safety characteristic that is different than the other portions. The portions 64-68 in this example are color-coded (e.g., using a background or overlay-type color representation technique) or otherwise presented in a manner that provides an indication of the safety characteristic of that particular portion of the area represented in the display.

For example, assume that the portion 64 is known to be a relatively high crime area while less crime typically occurs in the portion 68, and the least amount of crime typically occurs in the portion represented at 66. In this example, the portion 64 of the displayed area is presented to a user using a color (represented by the shading in the drawing) that is different than the color (represented by the different shading in the drawing) used in the presentation of the portions 66 and 68, respectively. The driver of the vehicle 20 or another individual within the vehicle has information available regarding relative risks of potential crime or threat in the vicinity of the current position of the vehicle and the area represented on the display.

One feature of the display output shown in FIG. 4 is that it allows a driver to notice when an intended route that is also shown on the display includes traveling through a potentially dangerous area. The driver may use the system 22 to select an alternate route that avoids such an area or may drive in a different manner when passing through such an area.

Although every portion of the area on the display shown in FIG. 4 has some indication regarding a determined safety characteristic, it is not necessary for all portions of the display to include such an indication. For example, only one segment or portion of the area represented on the display may have a safety characteristic that is considered worthy of reporting to an individual within the vehicle 20. The controller 30 in some embodiments only causes the display screen 42 to include an indication regarding a safety characteristic when there is a sufficient amount of potential danger or crime based upon information from the database 36. In many situations, the display will not include any safety characteristic information when the area represented on the display does not include any portions that have a relatively high crime rate, for example. When the expected crime rate is low, the display may be controlled to be a typical or normal display expected by the vehicle owner. In such embodiments, when there is additional color or another indication (e.g., text or a symbol indicative of a safety characteristic) provided on the display, the user readily recognizes such as an indication of an increase potential for encountering crime or a threat.

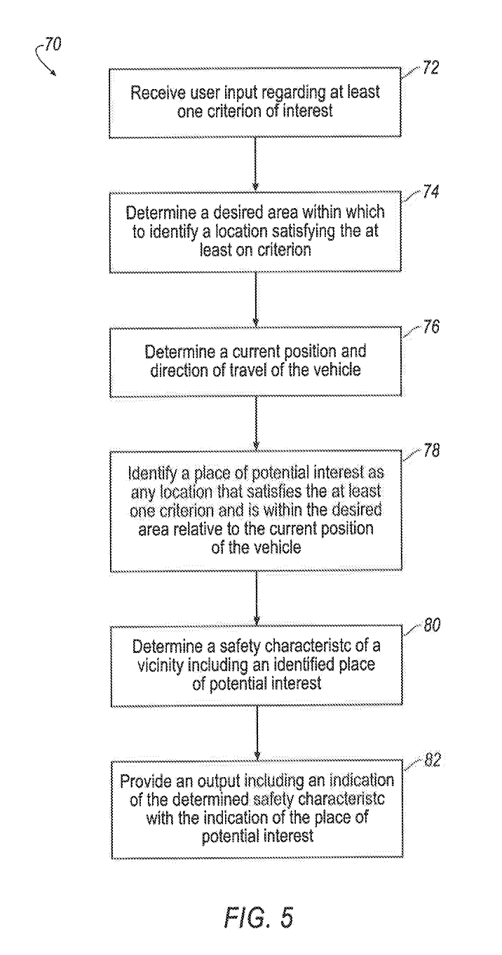

FIG. 5 is another flowchart diagram 70 that provides safety characteristic information in a more particular manner. In the flowchart 70, the user interface means 40 receives user input regarding at least one criterion of interest to the user at 72. The user input may specify a particular location to which an individual wishes to travel, may be a request for directions to a particular location, or may be search criteria for locating potential places of interest. For example, the user input may specify a particular type of business establishment, for example, that an individual would like to know about while driving the vehicle 20.

At 74, the controller 30 determines a desired search area within which to locate places of potential interest that satisfy the user's criterion. In some embodiments the desired search area is a range that is preset and does not require any user input. In other embodiments, the user provides input regarding a desired search area within which to identify a location satisfying the at least one criterion. The desired search area may be defined in terms of a geographic distance, such as a search radius or range from a position of the vehicle 20. The vehicle position may be a current position or an upcoming position along a preplanned route. The desired search area may also be defined in terms of a maximum acceptable or desirable travel distance, which takes into account information regarding a potential route from a vehicle location to the location of a place of interest based on the criterion established by the user. A geographic distance and a travel distance may be different or the same depending on the configuration of road surfaces available to an individual for traveling from a current vehicle position to the position of a place of interest. The illustrated example embodiment allows a user to customize the size of the desired search area based on geographic distance or travel distance.

Another way in which the desired area may be defined in this example embodiment is by travel time between a vehicle location and the location of a place of interest that satisfies the at least one criterion input by the user. In some instances, an individual may not be concerned with the actual distance as much as being concerned with how long it will take to travel from a vehicle position or another vehicle position along a desired route to an intended destination, to a place of potential interest identified by the system 22. For example, a driver may not want to deviate from a current route for more than ten minutes. The illustrated example allows an individual to set the range or limit of the desired area based upon travel time.

Some embodiments use a combination of time and distance information to set or determine the size, scope or range of the desired area.

At 76, the controller 30 determines a current position and direction of travel of the vehicle 20. In one example, the controller 30 utilizes known global positioning and navigation techniques for making the determinations at 76. The determinations at 76 are optional in some embodiments at least under some circumstances but will be useful for many implementations. For example, the controller 30 will know a predetermined or planned route of the vehicle 20 under some circumstances and the desired search area can be determined relative to that route or any portion of that route. In such cases, the identified places of potential interest are within the range or scope of the desired search area anywhere along the route.

At 78, the controller 30 identifies any location that satisfies the at least one criterion and is within the desired search area as a place of potential interest. In this example, the controller 30 gathers information from the database 36, which also includes information regarding various establishments (in addition to the safety information mentioned above). When the desired search area includes the location of a business (and it meets the user's criterion), that business is identified as a place of potential interest.

At 80, the controller 30 determines a safety characteristic of a vicinity that includes at least a selected one of the identified places of potential interest. In some embodiments, the controller 30 makes such a determination in response to or based upon user input selecting an identified place within the desired area. The user may touch one of the representations or indications of an identified place of interest on the display screen 42, for example, to provide input of a desire for more information regarding that place. Some embodiments allow for the user to speak the name or another identifier of one of the identified places of potential interest to provide audio input regarding a desire for more information regarding that place. Other embodiments have other or additional ways in which a user can provide such input.

At 82, the controller 30 causes the user interface 40 to provide an indication of the determined safety characteristic with the indication of the selected place of interest. The indication at 82 may comprise words, symbols, colors or a combination of these. One example includes using a first color (e.g., green) when the determined safety characteristic corresponds to a first risk or threat level that includes a relatively low expectation that an individual is likely in danger of being a victim of a crime or harm in that vicinity. The first color is appropriate, for example, when the vicinity is in a low crime rate area or includes plenty of exterior lighting at night. A second, different color (e.g., red) is included in the output when the safety characteristic of the vicinity corresponds to a relatively higher expectation of crime or harm in the vicinity. More than two possible safety characteristic levels and corresponding, distinguishable indications are included in some embodiments.

Other embodiments include an indication of the determined safety characteristic for all identified places of potential interest. For example, all indications of potential places of interest on some displays are color-coded based on the determined safety characteristic for the vicinity associated with each place of potential interest. With such embodiments, a user need not request additional information regarding any of the places of potential interest to get information through the output regarding the determined safety characteristics.

FIG. 4 includes one example way of providing the type of output generated according to the techniques summarized in FIG. 5. In FIG. 4, several places of potential interest 90, 92 and 94 are schematically shown within the desired search area represented at 96. The color-coding of the different portions of the area represented on the display provide the indication of the at least one safety characteristic for each place of potential interest. In the example of FIG. 4, the region 64 is known to have a higher crime rate compared to the region 66. Given that the place of potential interest 90 appears on the display within the region 64, a driver can decide whether traveling to that place of potential interest is desirable even if it is closer than other places of potential interest 92 and 94, which are in an area that has a lower crime rate or a lower expectation of encountering crime or a threat. Such information is particularly useful when an individual is traveling through an area that the individual is unfamiliar with or otherwise is unsure about.

When the vehicle position used for locating places of potential interest includes any upcoming position along a predetermined route known to the controller, the display may provide indications of such places anywhere along the route. This feature allows a user to learn about places of potential interest later in the planned journey that may provide safer or more comfortable conditions compared to the vicinity surrounding any identified places that are currently within the desired search area relative to the current vehicle position.

FIG. 6 is another example type of output that provides the type of information generated according to the technique summarized in FIG. 5. In FIG. 6, several places of potential interest 102, 104 and 106 have been identified within the desired search area 96. In this example, the display 100 includes an indication at 110 regarding the determined safety characteristic for the vicinity that includes the place of potential interest 102. In this example, the user selects the place 102 and a dialog box or pop up display appears on the display screen 42 including the indication 110. In this instance, the indication 110 includes words or symbols and the displayed output 100 does not include the shading or color-coding that was included in the example output of FIG. 4.

A variety of additional indications or combinations of selected ones of the indications described above may be provided in some embodiments. Some embodiments allow the vehicle owner to customize the way in which such information is provided to meet their particular needs.

Additionally, more information or other formats of information may be provided through the user interface 40. The example outputs of FIGS. 4 and 6 demonstrate two example embodiments of an output that includes an indication of a determined safety characteristic of a region, area or vicinity including at least one of a current position of a vehicle, a route, and an identified place of potential interest.

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

We claim:

1. A vehicle navigation system, comprising:
user interface means for providing an output including at least a display to a user; and
control means for determining an area represented by the display, determining at least one safety characteristic of at least one portion of the area represented by the display, and causing the user interface means to include an indication of the determined safety characteristic with the display.

2. The system of claim 1, wherein the control means determines the safety characteristic based on information from a remotely accessible database.

3. The system of claim 1, wherein the safety characteristic is based on at least one of:
lighting in the portion of the area;
a crime rate in the portion of the area;
information regarding reported crimes in the portion of the area; and
information regarding a potential threat in the portion of the area.

4. The system of claim 1, wherein
the indication of the safety characteristic comprises a color on the display screen;
the color is a first color when the safety characteristic corresponds to a first expectation that an individual may be in danger of a possible crime or threat in the portion of the area; and
the color is a second, different color when the safety characteristic corresponds to a second, higher expectation that an individual may be in danger of a possible crime or threat in the portion of the area.

5. The system of claim 4, wherein
the control means determines a current position of a vehicle associated with the system;
the output includes an indication of the current position of the vehicle within the area; and
the representation of the area includes the first color for portions of the area where the first expectation exists and includes the second color for portions of the area where the second expectation exists.

6. The system of claim 1, wherein the indication of the at least one safety characteristic comprises at least one of text and a symbol.

7. The system of claim 1, wherein
the user interface means receives user input regarding at least one criterion of interest to the user;
the control means identifies a place of potential interest as a location that satisfies the at least one criterion;
the control means determines the at least one safety characteristic for a vicinity of the identified place of potential interest; and
the user interface means includes an indication of the determined at least one safety characteristic associated with an indication of the identified place of potential interest.

8. The system of claim 7, wherein
the user interface means receives user input regarding a desired search area surrounding a position of a vehicle associated with the system;
the control means identifies any locations within the desired search area that satisfy the at least one criterion as places of potential interest;
the output includes an indication of a position of any identified place of potential interest relative to the position of the vehicle.

9. The system of claim 8, wherein the position of the vehicle is a current position of the vehicle and the control means
dynamically updates a position of the desired search area based on changes in the current position of the vehicle; and
dynamically identifies any places of potential interest based on the updated desired search area.

10. The system of claim 7, wherein
the position of the vehicle is a predetermined route; and
the control means identifies any locations within the desired search area along the route.

11. A vehicle comprising the system of claim 1.

12. A method of providing information to a driver of a vehicle through a vehicle navigation system user interface that includes at least a display screen, the method comprising:
determining an area represented by a display provided on the display screen;
determining at least one safety characteristic of at least one portion of the area represented by the display; and
including an indication of the determined safety characteristic with the display.

13. The method of claim 12, comprising determining the safety characteristic based on information from a remotely accessible database.

14. The method of claim 12, wherein the safety characteristic is based on at least one of:
lighting in the portion of the area;
a crime rate in the portion of the area;
information regarding reported crimes in the portion of the area; and
information regarding a potential threat in the portion of the area.

15. The method of claim 12, wherein the indication of the safety characterization comprises a color on the display;
the color is a first color when the safety characteristic corresponds to a first expectation whether an individual may be in danger of a possible crime or threat in the portion of the area; and
the color is a second, different color when the safety characteristic corresponds to a second, higher expectation that an individual may be in danger of a possible crime or threat in the portion of the area.

16. The method of claim 15, comprising determining a current position of the vehicle;
providing an indication of the current position of the vehicle on the display with the area represented by the display being an area surrounding the current position of the vehicle; and
including the first color for portions of the area surrounding the vehicle where the first expectation exists and including the second color for portions of the area surrounding the vehicle where the second expectation exists.

17. The method of claim 12, wherein the indication of the at least one safety characteristic comprises at least one of text or a symbol.

18. The method of claim 12, comprising
receiving user input regarding at least one criterion of interest to the user;
identifying the place of potential interest as a location that satisfies the at least one criterion;
determining the at least one safety characteristic of a vicinity if the identified place of potential interest; and
including an indication of the at least one safety characteristic with an indication of the identified place of potential interest.

19. The method of claim 18, comprising receiving user input regarding a desired search area surrounding a position of the vehicle;
identifying any locations within the desired search area that satisfy the at least one criterion as a place of potential interest; and
including an indication of a position of any identified place of potential interest relative to the position of the vehicle on the display.

20. The method of claim 19, wherein the position of the vehicle is a current position of the vehicle and the method comprises
dynamically updating a position of the desired search area based at least on changes in the current position of the vehicle; and
dynamically identifying any places of potential interest based on the updated desired search area.

21. The method of claim 19, wherein the position of the vehicle is along a predetermined route and the method comprises identifying any locations within the desired search area along the route.

22. A vehicle comprising a controller and a display screen configured to perform the method of claim 12.
